(19) United States
(12) Patent Application Publication
(10) Pub. No.: US 2024/0039432 A1
(43) Pub. Date: Feb. 1, 2024

(54) METHOD FOR MAGNETIC BRAKING OF A STEERING COLUMN INCLUDED IN A STEERING SYSTEM OF A VEHICLE

(71) Applicant: JTEKT EUROPE, Irigny (FR)

(72) Inventors: Arnaud BOUCHET, Oullins (FR); Pierre LARMINY, Venissieux (FR); Roch MONNET, Brindas (FR)

(73) Assignee: JTEKT EUROPE, Irigny (FR)

(21) Appl. No.: 18/018,305

(22) PCT Filed: Jul. 23, 2021
(86) PCT No.: PCT/FR2021/051387

§ 371 Date: Jan. 27, 2023

(30) Foreign Application Priority Data
Jul. 28, 2020 (FR) FR2007962

(51) Int. Cl. H02P 3/22; B62D 5/00

(52) U.S. Cl. CPC H02P 3/22; B62D 5/006

(57) ABSTRACT

A method for magnetic braking of a steering column included in a steering system of a vehicle to facilitate installation and uninstallation of the driver in the vehicle and to protect angular mechanical stops arranged on either side of the steering column, said vehicle including a vehicle engine, said steering system including at least: the steering column connected to a steering wheel, the angular mechanical stops arranged on either side of the steering column, a force feedback module fixed to the steering column, said force feedback module including an electric motor, a reducer and a torque and/or angle sensor, said method including the magnetic braking of the steering column connected to the steering wheel applied by the electric motor of the force feedback module when said electric motor of the force feedback module is not powered.

The present invention concerns a magnetic braking method of a steering column included in a steering system of a vehicle. The present invention is particularly suitable for the automotive industry.

Generally, in a motor vehicle equipped with a Steer-by-Wire type steering system, there is no mechanical link between the control member of the wheels, namely a steering wheel for example, and the steered wheels.

The traditional steering column is replaced by electrical connections capable of transmitting control commands generated from the rotation of the steering wheel to actuators, generally electrical, which control the steering angle of the steered wheels.

In a steering control system of the Steer-by-Wire type, it is necessary to reproduce for the driver the driving sensations essential for good control of a vehicle.

The sensations perceived by the driver via the steering wheel play a key role in his ability to steer his vehicle.

To date, many steering systems are known which are equipped with a force feedback module whose main function is to deliver a force feedback on the steering wheel in such a way that the driver feels the state of the road as the change of grip or the like in the same way as with a mechanical type motor vehicle steering system.

This force feedback module thus simulates the forces that would be felt with a conventional mechanical steering system. The steering column connected to the steering wheel can freely pivot, being however limited by angular mechanical stops designed to protect in particular the electrical harnesses of the steering wheel generally arranged on either side of the steering column.

In the automotive industry, the steering control system of the Steer-by-Wire type makes it possible to move towards the development of vehicles with autonomous driving phases, that is to say driving phases during which the driver is relieved of any action on the steering wheel. Moreover, the traditional steering column is generally equipped with a «Neiman» type anti-theft device. Alternatively, the force transmitted by the wheels can induce the anti-theft function. This anti-theft device or function has the main function of preventing or make more difficult vehicle theft by blocking the steering system when the vehicle ignition is off. This anti-theft device or function has the secondary effect of making it easier to install and uninstall the driver. Indeed, the steering wheel acts as a handle so that the driver can lean on it to enter and exit the vehicle.

In a Steer-by-Wire type steering control system, the anti-theft device is removed since the anti-theft function is secured by the fact that there is no longer any mechanical link between the steering wheel and the wheels. Thus, when the ignition is off, it is not possible to make the vehicle turn using the steering wheel. Moreover, the absence of the anti-theft device allows a gain in volume of the force feedback module.

However, the installation and uninstallation of the driver are no longer facilitated, and the angular mechanical stops arranged on either side of the steering column are no longer protected. Indeed, when the driver unlocks the vehicle using a remote transmitter or a key to be inserted into the vehicle door latch, the steering wheel is no longer blocked. If the driver leans on the steering wheel, it is likely to turn, creating a risk of injury to the driver. Moreover, if the steering wheel is rotated too quickly, the angular mechanical stops will be violently struck and be damaged.

It is known to add a steering wheel blocking system which operates when the vehicle ignition is off. The driver can lean on the steering wheel to use it as a handle when getting in and out of the vehicle. Furthermore, this function makes it possible to protect the angular mechanical stops which limit the angular stroke of the steering wheel.

Nevertheless, the integration of a steering wheel blocking system on a Steer-by-Wire type steering system will lead to an increase in the volume of the steering system, an increase in the weight of the steering system, the addition of additional electric wires if the steering wheel blocking system is electric and an increase in the cost of production.

The object of the invention is to remedy the aforementioned drawbacks by proposing a steering system of the Steer-by-Wire type facilitating the installation and uninstallation of the driver in the vehicle and protecting the angular mechanical stops on either side of the steering column.

The subject of the present invention is a method for magnetic braking of a steering column included in a steering system of a vehicle to facilitate the installation and uninstallation of the driver in the vehicle and to protect the angular mechanical stops arranged on either side of the steering column, said vehicle comprising a vehicle engine, said steering system comprising at least:
the steering column connected to a steering wheel, the angular mechanical stops placed on either side of the steering column,
a force feedback module fixed to the steering column, said force feedback module comprising an electric motor, a reducer and a torque and/or angle sensor,

Said method comprising the magnetic braking of the steering column connected to the steering wheel applied by the electric motor of the force feedback module when said electric motor of the force feedback module is not powered.

The method according to the invention allows magnetic braking of the steering column connected to the steering wheel when the electric motor of the force feedback module is not electrically powered. When the electric motor of the force feedback module changes from an active to inactive state, that is to say from a powered to unpowered state, for example a short-circuit is made between the phases of the motor generating the magnetic braking of the steering column. The magnetic braking of the steering column linked to the steering wheel allows the driver to lean on the steering wheel to get in and out of the vehicle. Thus, the steering wheel acts as a handle and facilitates entry and exit from the vehicle. Moreover, the method according to the invention makes it possible to protect the angular mechanical stops arranged at the end of the angular stroke. Furthermore, the magnetic braking carried out in the electric motor of the force feedback module has the advantage of being neutral in terms of vehicle energy consumption, of not adding additional mass to the steering column and of not increasing the size of the steering column.

In an embodiment, the magnetic braking is achieved through a switching device present in the electric motor of the force feedback module.

In an embodiment, the magnetic braking is achieved by a short-circuit created in the electric motor of the force feedback module. For example, the switching device creates the short-circuit in the electric motor of the force feedback module.

In an embodiment, the electric motor comprises three phases. In this embodiment, the short-circuit can be three-phased, that is to say carried out on the three phases, or two-phased, that is to say carried out on two phases.

In an embodiment, the switching device may comprise an electromechanical relay capable of creating the short-circuit. By electromechanical relay is meant a device making it possible to establish or interrupt the continuity of an electrical circuit, by switching contacts.

In an embodiment, the switching device comprises a static relay capable of creating the short-circuit. By static relay is meant a device making it possible to switch an electric current without relying on mechanical or electromechanical elements. A static relay is preferably composed of an assembly of electronic components, in particular semiconductors. The static relay can be MOSFET technology.

In an embodiment, the switching device comprises resistors.

In an embodiment, the electric motor of the force feedback module is connected to the steering column through the reducer. In this embodiment, the braking torque is multiplied.

In an embodiment, the electric motor of the force feedback module is with permanent magnets of the synchronous or direct current type.

In an embodiment, the steering device according to the invention comprises steering control means of the steering wheels of the vehicle. For example, these steering means are controlled by an electronic control unit (ECU) of the vehicle or by the position of the steering wheel induced by the driver.

For example, the vehicle braking means comprise a rack connected to the steered wheels of the vehicle and an actuator fixed to the rack, said actuator making it possible to move the rack. The invention will be better understood, thanks to the description below, which relates to one or more embodiments according to the present invention, given by way of non-limiting examples and explained with reference to the appended schematic drawings, in which:

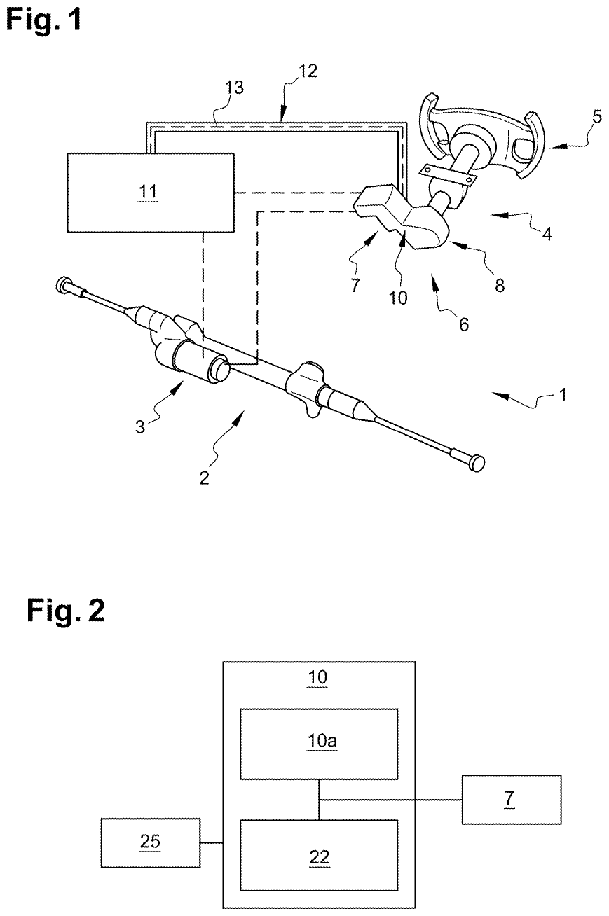

FIG. 1 is a steering system according to the invention,

FIG. 2 is a diagram illustrating an electric motor of the force feedback module according to the invention,

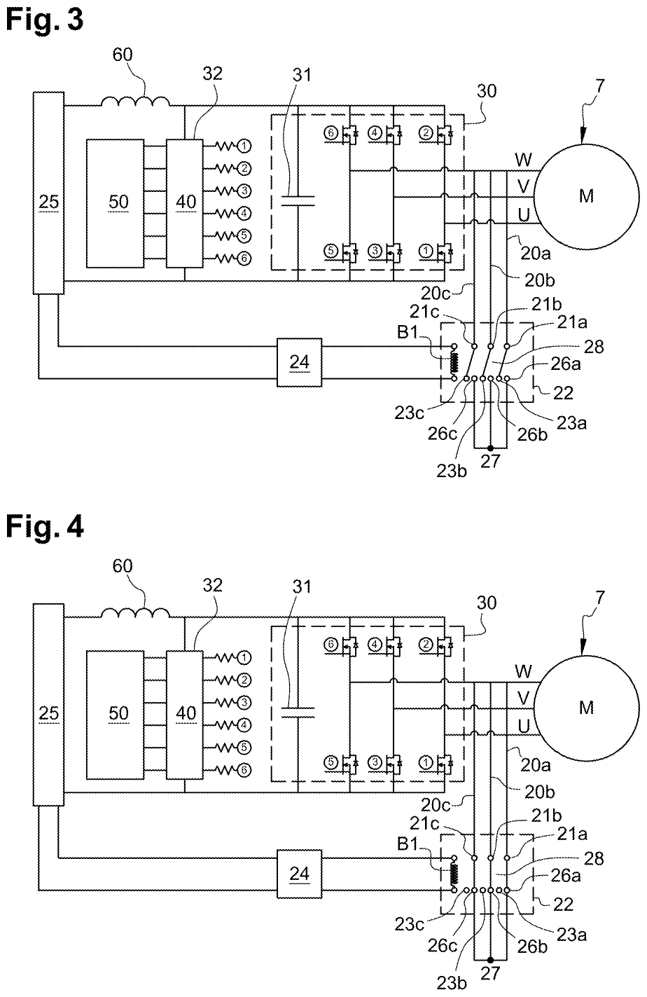

FIG. 3 is an embodiment of an electric motor of the force feedback module according to the invention and

FIG. 4 is another embodiment of an electric motor of the force feedback module according to the invention.

FIG. 1 illustrates a steering system 1 of a vehicle (not shown), said vehicle comprising a vehicle engine (not shown).

The steering system 1 may comprise a rack 2, a steering motor 3 which acts on a rack so as to pivot on the steered wheels (not shown) of the vehicle, a steering column 4 connected to a steering wheel 5, angular mechanical stops (not shown) arranged on either side of the steering column 4. Furthermore, the steering system 1 may comprise a force feedback module 6 fixed to the steering column 4, said force feedback module comprising an electric motor 7, a reducer 8 and a torque and/or angle sensor (not shown).

In this example, the force feedback module 6 comprises a controller 10 connected to the electric motor 7.

The vehicle may also comprise a CAN bus 12. This network 12 comprises the electrical wiring 13 of the vehicle configured to establish an electrical connection and communication between the electric motor 7 of the force feedback module 6, the controller and various components of the vehicle. The Wire harness 13 can generally be connected to the vehicle ECU 11.

FIG. 2 illustrates an example in which the controller 10 includes a nominal control device 10a. Moreover, the force feedback module 6 comprises a switching device 22 and a power supply 25.

The controller 10, for example supplied in electrical energy by the power network of the vehicle, controls the electric motor 7. When the controller 10 is supplied in electrical energy, that is to say when the electric motor 7 is active, the nominal control device 10a drives the electric motor 7 for example by dynamic control of the electromagnetic torque. This type of device generally consists of a single-phase or multi-phase inverter through which an electric current passes. When the controller 10 is not powered, that is to say when the electric motor 7 is inactive, the electric motor is automatically short-circuited, for example by means of a switching device 22 so as to generate a braking torque when the motor 7 is rotating. The braking torque makes it possible to significantly slow the speed of the steering wheel when a user acts on the steering wheel to get into or to get out of a vehicle. In addition, the angular mechanical stops are protected and the driver can lean on the vehicle steering wheel to get in and out of the vehicle.

FIG. 3 illustrates an electric motor 7 which can for example be made in the form of a permanent magnet motor with or without a brush.

In this example, it is a three-phased, permanent-magnet motor which correspondingly contains three motor windings. The electric motor 7 therefore includes three electrical connections U, V, W each connected, inside the electric motor 7 to one of the windings of this electric motor 7. The connections U, V, W are connected through connecting lines 20a, 20b, 20c corresponding to inputs 21a, 21b, 21c of a switching device 22 with three poles. This switching device 22 has first outputs 23a, 23b, 23c and second outputs 26a, 26b, 26c of the switching device 22. The second outputs 26a, 26b, 26c are each connected to a star connection point 27 and thereby form a star branch circuit. For example, the switching device 22 comprises a coil B1 connected to a power supply 25 of the electric motor 7 so that a voltage is applied to the coil so as to obtain a static relay. For example, the static relay is MOSFET technology.

The switching device 22 may comprise switching means 28 operable synchronously by the coil B1 which, in a first switching position represented in FIG. 3, connect the inputs 21a, 21b, 21c to the first outputs 23a, 23b, 23c. In a second switching position, the switching means 22 connect the inputs 21a, 21b, 21c to the second outputs 26a, 26b, 26c. Thus, when a voltage is applied to the coil B1, the inputs 21a, 21b, 21c will be connected to the second outputs 26a, 26b, 26c. In other words, a short-circuit is created. When the ignition is off, the inputs 21a, 21b, 21c will be connected to the first outputs 23a, 23b, 23c.

During operation in steer-by-wire mode of the steering system 1, the switching means 28 of the switching device 22 are in their first switching position if the motor 7 of the force feedback 6 is powered. If the electric motor 7 of the force feedback module 6 is not powered, the switching means 28 of the switching device 22 are switched to their second switching position.

The electric motor can also comprise a control module 30 consisting of a transistor bridge comprising inputs numbered from 1 to 6 and a capacitor 31. An electronic control circuit 40 (also called the «gate driver unit») performs the interface between a microcontroller 50 and the control module 30.

The electronic control circuit 40 can be connected to outputs numbered 1 to 6 of the control module 30. The electronic control circuit 40 is for example connected to the power supply 25 of the electric motor 7 via a coil B2.

FIG. 4 illustrates the electric motor 7 of the force feedback module 6 according to another embodiment in which the second outputs 26a, 26b, 26c of the switching device 22 are each connected, by electric resistors 29a, 29b, 29c, to a star connection point 27 and thereby form a star connection circuit. In this example, the electric motor 7 of the force feedback module 6 is inactive. Thus, the switching means 28 of the switching device 22 are switched to their second switching position creating a short-circuit.

When the electric motor 7 of the force feedback module 6 is not powered (FIG. 4), for example the connections U, V, W of the electric motor 7 are connected together electrically in a star via the electrical resistors 29a, 29b, 29c. The electric motor 7 is then separated from the power supply 25. When the driver leans on the steering wheel 5, because the connections U, V, W are connected together by the resistors 29a, 29b, 29c, electric currents can establish, with, as a consequence, the generation in the electric motor 7 of braking torques acting against the movement of the steering wheel 5 induced by the driver.

The installation and uninstallation of the driver in the vehicle is thus facilitated because a resistant torque is created when the driver acts on the steering wheel in particular during its installation and uninstallation in a vehicle and the angular mechanical stops of the steering column are protected.

1. A method of magnetic braking of a steering column included in a steering system of a vehicle in order to facilitate the installation and uninstallation of the driver in the vehicle and to protect the angular mechanical stops arranged on either side of the steering column, said vehicle comprising a vehicle engine, said steering system comprising at least:
the steering column connected to a steering wheel, the mechanical angular stops arranged on either side of the steering column,
a force feedback module fixed to the steering column, said force feedback module comprising an electric motor, a reducer and a torque and/or angle sensor,
said method comprising the magnetic braking of the steering column connected to the steering wheel applied by the electric motor of the force feedback module when said electric motor of the force feedback module is not powered.

2. The magnetic braking method according to claim 1, wherein the magnetic braking is carried out by means of a switching device present in the electric motor of the force feedback module.

3. The magnetic braking method according to claim 1, wherein the magnetic braking is carried out by a short-circuit created in the electric motor of the force feedback module.

4. The magnetic braking method according to claim 2, wherein the switching device comprises an electromechanical relay able to create the short-circuit.

5. The magnetic braking method according to claim 2, wherein the switching device comprises a static relay able to create the short-circuit.

6. The magnetic braking method according to claim 1, wherein the switching device comprises.

7. The magnetic braking method according to claim 1, wherein the electric motor of the force feedback module is connected to the steering column via the reducer.

8. The magnetic braking method according to claim 1, wherein the electric motor of the force feedback module is with permanent magnets of the synchronous or direct current type.
